(19) United States
(12) Patent Application Publication
(10) Pub. No.: US 2012/0114121 A1
(43) Pub. Date: May 10, 2012

(54) METHOD OF TRANSMITTING AND RECEIVING CONTENT

(76) Inventors: Souhwan JUNG, Seoul (KR); HyoSun ROH, Seoul (KR); Young Han KIM, Seoul (KR)

(21) Appl. No.: 13/078,269

(22) Filed: Apr. 1, 2011

(30) Foreign Application Priority Data
Nov. 10, 2010 (KR) 10-2010-0111351
Jan. 28, 2011 (KR) 10-2011-0008801

(51) Int. Cl. H04N 7/167

(52) U.S. Cl. 380/242

(57) ABSTRACT

Provided is a method of transmitting and receiving content. The method includes (a) transferring, at a content server, a service key to a mobile terminal, (b) transferring, at the content server, a number to the mobile terminal, (c) scrambling, at the content server, content and transferring the scrambled content to the mobile terminal, (d) updating, at the mobile terminal, the service key on the basis of the number, and (e) descrambling, at the mobile terminal, the scrambled content using the updated service key.

### TECHNICAL FIELD

The described technology relates generally to a method of transmitting and receiving content.

### BACKGROUND

A conditional access system (CAS) causes a digital receiver of a user to determine whether or not to allow reception of a specific broadcasting program, thereby enabling only persons who pay a receiving fee to view programs. The CAS includes scrambling technology, encryption technology, and a user service support function. The scrambling technology is a conditional access function of mixing voice data, video data, etc. to protect it from unauthenticated reception. The encryption technology encrypts content so as to be played only with a specific receiver and decrypts the content using a control word. The service support function provides users with various forms of services on the basis of the scrambling technology and the encryption technology.

### SUMMARY

A conditional access system (CAS) used for cable Internet protocol television (IPTV) makes use of a hierarchical key for service security and content security. A control word is used to scramble media content, and a service key is used to safely transfer the control word. To safely update the service key, the service key is encrypted and transferred using a master key that is stored in a smart card at initial service subscription. The control word is updated through an entitlement control message (ECM) at several-second to several-minute intervals, and the service key is updated through an entitlement management message (EMM) at several-minute to several-hour intervals or every day. Thus, when there are a large number of subscribers, key updates incur large communication overhead and require many network bandwidths.

Also, the CAS cannot establish a security channel for providing an IPTV service to a wireless terminal selected by a user because conventional CAS technology was provided for fixed set-top boxes. Thus, in a wireless environment, a CAS module should be installed in each wireless terminal, and a smart card for a CAS and a master key for each mobile terminal should be distributed in advance.

Embodiments of the present disclosure are aimed at reducing communication overhead resulting from a conventional CAS-based security system in a mobile IPTV environment. Also, embodiments of the present disclosure are aimed at reducing security delay resulting from a security system in a mobile IPTV environment. Further, embodiments of the present disclosure are aimed at providing a user with an IPTV service through a mobile terminal in a safe way anywhere in a mobile IPTV service environment whenever the user wants.

In one embodiment, a method of transmitting and receiving content is provided. The method includes: transferring, at a content server, a service key to a mobile terminal; transferring, at the content server, a number to the mobile terminal; scrambling, at the content server, content and transferring the scrambled content to the mobile terminal; updating, at the mobile terminal, the service key on the basis of the number; and descrambling, at the mobile terminal, the scrambled content using the updated service key.

In another embodiment, a method of transmitting and receiving content is provided. The method includes: receiving, at a mobile terminal, a service key from a content server; receiving, at the mobile terminal, a number from the content server; receiving, at the mobile terminal, scrambled content from the content server; updating, at the mobile terminal, the service key on the basis of the number; and descrambling, at the mobile terminal, the scrambled content using the updated service key.

In still another embodiment, a method of transmitting and receiving content is provided. The method includes: transferring, at a content server, a service key to a mobile terminal; transferring, at the content server, a number to the mobile terminal; scrambling, at the content server, content and transferring the scrambled content to the mobile terminal; having the service key updated on the basis of the number in the mobile terminal; and having the scrambled content descrambled using the updated service key by the mobile terminal.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 illustrates a security system for a mobile terminal according to an embodiment of the present disclosure;

FIG. 2 is a flowchart illustrating a security method for a mobile terminal according to an embodiment of the present disclosure; and

FIG. 3 is a flowchart illustrating a method of transmitting and receiving content according to an embodiment of the present disclosure.

### DETAILED DESCRIPTION

It will be readily understood that the components of the present disclosure, as generally described and illustrated in the Figures herein, could be arranged and designed in a wide variety of different configurations. Thus, the following more detailed description of the embodiments of apparatus and methods in accordance with the present disclosure, as represented in the Figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout.

Meanwhile, terms used herein are to be understood as follows.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” “on” versus “directly on,” etc.).

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

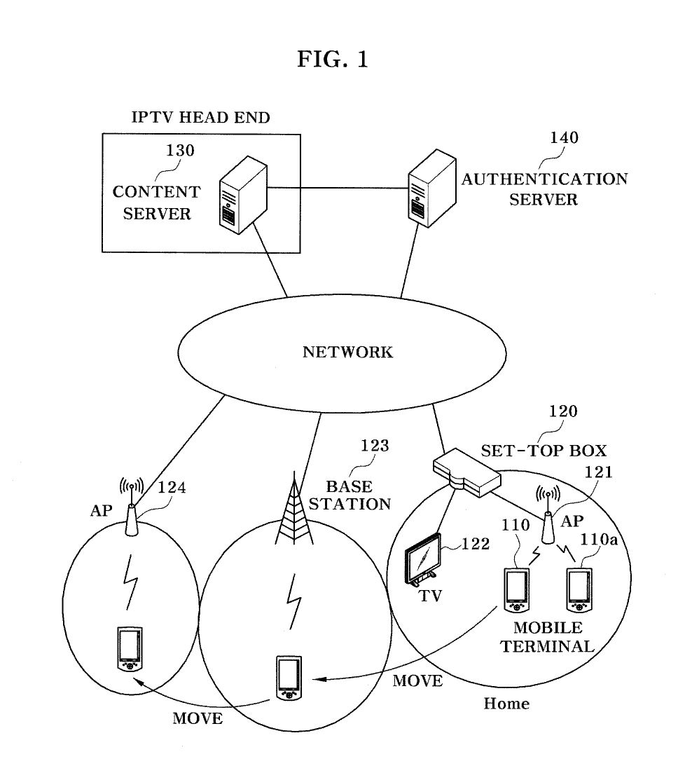

FIG. 1 illustrates a security system for a mobile terminal according to an embodiment of the present disclosure. Referring to FIG. 1, the security system for a mobile terminal includes a mobile terminal 110, a set-top box 120, a content server 130, and an authentication server 140.

At an initial stage, network access authentication of the mobile terminal 110 is performed by the authentication server 140. The mobile terminal 110 may register its identity (ID) and profile in the set-top box 120 and receive an Internet protocol television (IPTV) service from the content server 130. Here, the mobile terminal 110 may be able to support the IPTV service. For example, the mobile terminal 110 may include a smartphone, a tablet personal computer (PC), and a personal digital assistant (PDA). The network access authentication of the mobile terminal 110 is performed using extensible authentication protocol (EAP)-authentication and key agreement (AKA). Also, the mobile terminal 110 may include a terminal that can be equipped with a universal subscriber identity module (USIM) or smart card. The mobile terminal 110 may use wireless fidelity (WiFi), 3rd generation partnership project (3GPP), wireless broadband Internet (WiBro), world interoperability for microwave access (WiMAX), or Bluetooth as a wireless interface.

In a home, the mobile terminal 110 is connected to a set-top box as a television (TV) 122 for receiving an IPTV service and may receive the IPTV service. For example, the mobile terminal 110 may be wirelessly connected to the set-top box 120 through an access point (AP) 121. After IPTV service authentication of the mobile terminal 110 is finished through the set-top box 120, the mobile terminal 110 may receive the IPTV service even while mobile. For example, the mobile terminal 110 may access a network through a base station 123 or an AP 124, and receive the IPTV service. Also, the mobile terminal 110 used in a security system for a mobile terminal according to a prior agreement between a service provider and a user may be plural in number. Using an additional mobile terminal 110a, it is possible to receive the IPTV service in the same way as the mobile terminal 110.

The set-top box 120 is initially authenticated by the authentication server 140. Also, the mobile terminal 110 is registered in the set-top box 120 and allowed by the set-top box 120 to receive the IPTV service. Here, the set-top box 120 may use, for example, a smart card or a USIM. A wireless interface of the set-top box 120 may conform to, for example, Institute of Electrical and Electronics Engineers (IEEE) 802/a/b/g, or use Bluetooth. The mobile terminal 110 accessing the set-top box 120 to be authenticated may be plural in number. The number of the mobile terminals 110 may be determined according to a type of the IPTV service to which the user subscribes.

The content server 130 receives an IPTV service request directly from the mobile terminal 110, and transfers IPTV content to the authenticated mobile terminal 110. The broadcasting content may be scrambled by the content server 130 using a control word and transferred to the mobile terminal 110. Video on demand (VOD) content may be encrypted and transferred after mutual authentication between the content server 130 and the mobile terminal 110. The content server 130 may correspond to an IPTV head end as a center having technical equipment for transmitting content.

The authentication server 140 authenticates the set-top box 120 and the mobile terminal 110, thereby enabling the IPTV service. The authentication server 140 is present in an IPTV service management area. When a user subscribes to the IPTV service, the authentication server 140 may issue a USIM or smart card to the user. A master key for initial authentication may be stored in the USIM or smart card issued to the user and distributed. Network access authentication may be performed using EAP-AKA.

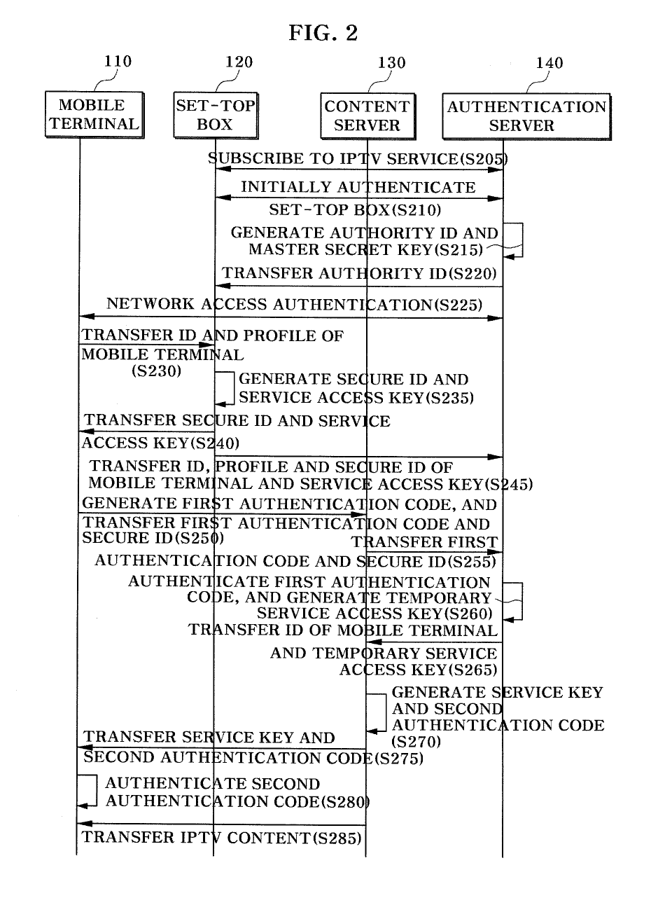

FIG. 2 is a flowchart illustrating a security method according to an embodiment of the present disclosure. Referring to FIG. 2, a user subscribes to an IPTV service (S205). For example, the user installs a set-top box 120 and is issued a USIM or smart card. When the user subscribes to the IPTV service off-line, the corresponding IPTV service provider safely stores a master key for initial authentication and a profile of the user in a smart card or USIM and issues the smart card or USIM. The USIM or smart card may contain the master key, a profile of the set-top box 120, an ID of the set-top box 120, and so on. For example, the profile of the set-top box 120 may include information about the service user, a type of the service, the number of mobile terminals 110 used by the user, and so on.

The authentication server 140 performs an initial authentication and initial registration process of the set-top box 120 online (S210). After the set-top box 120 is installed, the user equips the set-top box 120 with the smart card or USIM. Also, when the user boots the set-top box 120, the initial authentication and initial registration process can be performed by the authentication server 140 of the IPTV service provider online For example, the set-top box 120 may encrypt its ID and profile using the master key and transfer the encrypted ID and profile to the authentication server 140, so that the initial authentication can be performed.

E_{MK}[ID_{STB},Profile_{STB},nᵢ] [Expression 1]

In Expression 1, ID_{STB} denotes the ID of the set-top box 120, and Profile_{STB} denotes the profile of the set-top box 120. Here, the profile of the set-top box 120 may include the information about the service user, the type of the service, the number of mobile terminals 110 used by the user, and so on. nᵢ denotes a number. Expression 1 denotes the ID and profile of the set-top box 120 encrypted using the master key (MK). The encryption may be performed in various ways in which transmission and reception sides can recognize the encrypted data. The master key is generated by the authentication server 140, and is stored in the USIM or smart card to be issued for the initial authentication.

The authentication server 140 generates an authority ID and master secret key of the mobile terminal 110 (S215). The master secret key corresponds to the master key and the ID of the set-top box 120. The master key is issued by the authentication server 140 to the set-top box 120 using the smart card or USIM when the user initially subscribes to the service. The ID of the set-top box 120 is received from the set-top box. Here, the generated master secret key is for IPTV service access. The authority ID of the mobile terminal 110 corresponds to the ID of the set-top box 120 and an initial service key.

MSK_{S}=h[MK,ID_{STB},nᵢ]

AID_{MN}=h[ID_{STB},ISK_{IA},MobileNode,t_{IAi}] [Expression 2]

In Expression 2, MSK_{S} (Master Secret Key for IPTV service access) denotes the master secret key for IPTV service access, and MK (Master Key) denotes the master key. ID_{STB} (Identity of set-top box) denotes the ID of the set-top box 120, and nᵢ denotes a number. AID_{MN} (Authority Identity of mobile node) denotes the authority ID of the mobile terminal 110. A plurality of authority IDs may be issued according to the number of mobile terminals 110 of the user subscribing to the IPTV service. ISK_{IA} (Initial Service Key of IPTV service AAA) denotes the initial service key issued by the authentication server 140, which may be a personal key of the authentication server 140. MobileNode corresponds to a string denoting the mobile terminal 110, and t_{IAi} denotes time information of the authentication server 140. Also, the set-top box 120 may generate the same master secret key as generated by the authentication server 140. The set-top box 120 may generate the master secret key using the master key received from the authentication server 140 and the ID of the set-top box 120 itself.

The authentication server 140 transfers the authority ID of the mobile terminal 110 to the set-top box 120 (S220). At this time, a message transferred from the authentication server 140 to the set-top box 120 is encrypted using the master secret key.

E_{MSKS}[List_{AID}] [Expression 3]

In Expression 3, List_{AID} denotes an authority ID list, and a plurality of authority IDs may be generated according to the number of mobile terminals 110 stored in the profile of the set-top box 120. Expression 3 denotes transfer of the authority ID list encrypted using MSK_{S}, that is, the master secret key for IPTV service access. The encryption may be performed in various ways in which transmission and reception sides can recognize the encrypted data. The set-top box 120 receives the encrypted authority ID, thereby succeeding in initial authentication.

The mobile terminal 110 is initially booted and authenticated for network access by the authentication server 140 (S225). Here, the authentication server 140 may be a network authentication server integrated with or separated from the authentication server 140 of the IPTV service provider. The network access authentication of the mobile terminal 110 may be performed by the authentication server 140 using EAP-AKA. When the network access authentication of the mobile terminal 110 is successfully finished, the mobile terminal 110 and the set-top box 120 share a master secret key MSK_{N} for network access with each other. The mobile terminal 110 may use WiFi, 3GPP, WiBro/WiMAX, or Bluetooth as a wireless interface. Also, the mobile terminal 110 may be a terminal that can be equipped with a USIM and receive the IPTV service.

The mobile terminal 110 requests the set-top box 120 to register an ID and profile of the mobile terminal 110 itself in the set-top box 120 (S230). The mobile terminal 110 encrypts its ID and profile using the master secret key and transfers the encrypted ID and profile to the set-top box 120, thereby requesting registration of the encrypted ID and profile. For example, the master secret key may be a secret key for network access shared with the set-top box 120 through network access authentication. After the initial authentication, the user registers the mobile terminal 110 in the set-top box 120 to view IPTV without temporal and spatial limitations. At this time, a plurality of mobile terminals 110 may be registered in the set-top box 120.

E_{MSKN}[ID_{MN},Profile_{MN}] [Expression 4]

In Expression 4, ID_{MN} denotes the ID of the mobile terminal 110, and Profile_{MN} denotes the profile of the mobile terminal 110. Expression 4 denotes transfer of the ID and profile of the mobile terminal 110 encrypted using MSK_{N}, that is, the master secret key for network access. The encryption may be performed in various ways in which transmission and reception sides can recognize the encrypted data. The master secret key for network access is derived by hashing key values such as an integrity key (IK) and a cipher key (CK). Those of ordinary skill in the art will easily appreciate the IK, the CK, etc. derived as a result of the EAP-AKA initial authentication process.

The set-top box 120 generates a secure ID of the mobile terminal 110 and a service access key (S235). The secure ID of the mobile ID corresponds to the ID and authority ID of the mobile terminal 110. The authority ID of the mobile terminal 110 used to generate the secure ID of the mobile terminal 110 is received from the authentication server 140, and the ID of the mobile terminal 110 is received from the mobile terminal 110. The service access key corresponds to the master secret key and the ID of the mobile terminal 110.

SID_{MN}=h[ID_{MN},AID_{MN},t_{STB}]

SAK=h[MSK_{S},ID_{MN},t_{STBi},MobileNode] [Expression 5]

In Expression 5, SID_{MN} (Secure Identity of mobile node) denotes the secure ID. A plurality of secure IDs may be issued according to the number of mobile terminals 110 registered in the set-top box 120. AID_{MN} (Authority Identity of mobile node) denotes the authority ID, and t_{STB} and t_{STBi} denote time information of the set-top box 120. SAK (Service Access Key) denotes the service access key, and MSK_{S} (Master Secret Key for IPTV service access) denotes the master secret key for IPTV service access. ID_{MN} denotes the ID of the mobile terminal 110, and MobileNode corresponds to the string denoting the mobile terminal 110.

The set-top box 120 transfers the secure ID and the service access key to the mobile terminal (S240). In this case, the service access key and the secure ID are encrypted using the master secret key and transferred. Here, the master secret key is a master secret key for network access.

E_{MSKN}[SAK,SID_{MN}] [Expression 6]

In Expression 6, SAK denotes the service access key, and SID_{MN} denotes the secure ID of the mobile terminal 110. Expression 6 denotes transfer of the secure ID of the mobile terminal 110 encrypted using MSK_{N}, that is, the master secret key for network access, to ensure security. The encryption may be performed in various ways in which transmission and reception sides can recognize the encrypted data.

The set-top box 120 transfers the ID, secure ID, and profile of the mobile terminal 110 and the service access key to the authentication server 140 (S245). In this case, the set-top box 120 encrypts the ID, secure ID, and profile of the mobile terminal 110 and the service access key using the master secret key and transfers the encrypted data.

E_{MSKS}[ID_{MN},SID_{MN},Profile_{MN},t_{STBi},SAK] [Expression 7]

In Expression 7, ID_{MN} denotes the ID of the mobile terminal 110, SID_{MN} denotes the secure ID of the mobile terminal 110, and Profile denotes the profile of the mobile terminal 110. Here, the profile of the mobile terminal 110 may include channel selection information, an IPTV service type, etc. of the mobile terminal 110. t_{STBi} denotes the time information of the set-top box 120, and SAK denotes the service access key. Expression 7 denotes transfer of the ID, secure ID, and profile of the mobile terminal 110 and the service access key encrypted using MSK_{S}, that is, the master secret key for IPTV service access, to ensure security. The encryption may be performed in various ways in which transmission and reception sides can recognize the encrypted data.

The mobile terminal 110 generates a first authentication code, and transfers the first authentication code and the secure ID to the content server 130 (S250). For example, the mobile terminal 110 may subscribe to the IPTV service by transferring the first authentication code and the secure ID to the content server 130.

MAC_{SAK}=h[SAK,ID_{MN},SID_{MN},rᵢ] [Expression 8]

In Expression 8, MAC_{SAK} (Message Authentication Code) denotes the first authentication code, and is used to authenticate that the mobile terminal 110 is registered in a server and can receive the IPTV service. SAK (Service Access Key) denotes the service access key, and ID_{MN} (Identity of mobile node) denotes the ID of the mobile terminal 110. Also, SID_{MN} (Secure Identity of mobile node) denotes the secure ID, and rᵢ denotes a number selected by the mobile terminal 110 to generate the first authentication code.

The content server 130 transfers the first authentication code and the secure ID to the authentication server 140 (S255).

The authentication server 140 generates a temporary service access key and authenticates the first authentication code (S260), and transfers the ID and temporary service access key to the content server 130 (S265).

TSAK=h[SAK,rᵢ,ID_{MN},SID_{MN}]

MAC_{SAK}=h[SAK,ID_{MN},SID_{MN},rᵢ] [Expression 9]

In Expression 9, TSAK (Temporary Service Access Key) denotes the temporary service access key and may be used to generate a second authentication code and encrypt a service key. SAK (Service Access Key) denotes the service access key, and rᵢ denotes the number selected by the mobile terminal 110. MAC_{SAK} denotes the first authentication code, ID_{MN} denotes the ID of the mobile terminal 110, and SID_{MN} denotes the secure ID of the mobile terminal 110. The ID and secure ID of the mobile terminal 110 shown in Expression 9 have been stored in a database of the authentication server 140. The authentication server 140 generates a first authentication code and compares the generated first authentication code with the first authentication code that is generated and transferred by the mobile terminal 110 to the content server 130. When the two first authentication codes are the same, the authentication server 140 may authenticate the mobile terminal 110 as a registered terminal.

The content server 130 generates a second authentication code and a service key (S270).

MAC_{TSAK}=h[TSAK,rᵢID_{MN}]

SKᵢ=h(SK,kᵢ) [Expression 10]

In Expression 10, MAC_{TSAK} (Message Authentication Code for Temporary Service Access Key) denotes the second authentication code, and TSAK (Temporary Service Access Key) denotes the temporary service access key. rᵢ denotes the number selected by the mobile terminal 110, and ID_{MN} denotes the ID of the mobile terminal 110. Skᵢ denotes the service key, which is used to encrypt a control word used for protection of IPTV content. SK denotes a service key that is transferred by the authentication server 140 to the content server 130 for the first time to encrypt the control word. Also, SK may be received from the authentication server 140 when the content server 130 is initially booted into the system. kᵢ is a number that may be used for update of the service key.

The content server 130 transfers the second authentication code and the service key to the mobile terminal 110 (S275). For example, the content server 130 encrypts the service key and the value of k using the temporary service access key and transfers the encrypted service key and value of k to the mobile terminal 110. Also, the content server 130 transfers the second authentication code and the value of r to the mobile terminal 110. When the content server 130 updates the service key, the content server 130 transfers kᵢ having been used to generate a new service key to the mobile terminal 110 together with an entitlement control message (ECM). Thereafter, when SKᵢ is periodically updated, the content server 130 selects new kᵢ₊ⱼ and hashes selected kᵢ₊ⱼ together with previously used SKᵢ thereby generating SKᵢ₊ⱼ, that is, the new service key. Here, j denotes a number. Also, the content server 130 transfers kᵢ₊ⱼ to the mobile terminal 110 together with the ECM so that respective users can update SKᵢ. Since the conditional access system (CAS) does not use an entitlement management message (EMM) but only uses the ECM, a load of a wireless bandwidth caused by using an EMM can be reduced.

E_{TSAK}[SKᵢ,kᵢ] [Expression 11]

In Expression 11, TSAK denotes the temporary service access key, Sk, denotes the service key, and k, denotes the number. Expression 11 denotes transfer of the service key and the number kᵢ encrypted using the temporary service access key, to ensure security. The encryption may be performed in various ways in which transmission and reception sides can recognize the encrypted data. The service key may be used for descrambling when the mobile terminal 110 receives scrambled content from the content server 130.

The mobile terminal 110 authenticates the second authentication code (S280). For example, the mobile terminal 110 generates a second authentication code and compares the generated second authentication code with the second authentication code received from the content server 130. When the two second authentication codes are the same, the mobile terminal 110 authenticates the content server 130.

MAC_{TSAK}=h[TSAK,rᵢ,ID_{MN}] [Expression 12]

In Expression 12, MAC_{TSAK} denotes the second authentication code, and

TSAK denotes the temporary service access key. IDᵣ denotes the ID of the mobile terminal 110, and r, denotes the number selected by the mobile terminal 110. After the mobile terminal 110 and the content server 130 mutually authenticate the first authentication code and the second authentication code, the mobile terminal 110 may receive the IPTV service from the content server 130.

The content server 130 transfers IPTV content to the mobile terminal 110 (S285). For example, the content server 130 transfers content scrambled using a control word to the mobile terminal 110. Here, the control word may vary at intervals of several seconds, and the scrambled content is encrypted using the service key and transferred to the mobile terminal 110. The mobile terminal 110 may descramble the scrambled content using the service key received from the content server 130.

E_{SKi}[CW] [Expression 13]

In Expression 13, Skᵢ denotes the service key. Expression 13 denotes that the content server 130 scrambles the content using the control word, encrypts the content using the service key, and transfers the encrypted content. The encryption may be performed in various ways in which transmission and reception sides can recognize the encrypted data. The service key may be updated with the value of kᵢ₊ⱼ received from the content server 130. Here, j denotes a number. When the content server 130 transfers additional content to the mobile terminal 110, the content server 130 may newly encrypt the additional content using the updated service key. Also, after decrypting the control word newly encrypted and transferred, the mobile terminal 110 may receive the content using the control word.

The mobile terminal 110 capable of using the IPTV service may be plural in number. Steps 215 to 285 may be performed on an additional mobile terminal 110a, and an additional authority ID, a secure ID, an ID, first and second authority IDs, a service access key, a temporary service access key, etc., may be issued to the additional mobile terminal 110a.

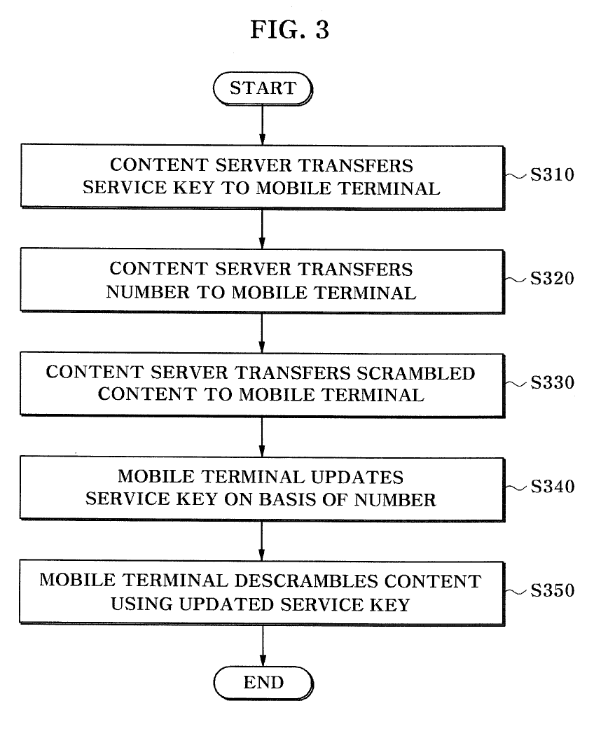

FIG. 3 is a flowchart illustrating a method of transmitting and receiving content according to an embodiment of the present disclosure. Referring to FIG. 3, a content server 130 transfers a service key to a mobile terminal 110 (S310). For example, the content server 130 may transfer the service key to the mobile terminal 110, scramble initial content to be transmitted by the content server 130 itself, and transfer the scrambled initial content to the mobile terminal 110. Here, the content is scrambled using a control word, and encrypted using the service key. Also, the control word may vary at predetermined time intervals of, for example, three seconds. The mobile terminal 110 may descramble the scrambled content using the service key.

The content server 130 transfers a number to the mobile terminal 110 (S320). The number received by the mobile terminal 110 may be used to update the service key.

E_{TSAK}[SKᵢ,kᵢ] [Expression 14]

In Expression 14, TSAK denotes a temporary service access key, SK, denotes the service key, and kᵢ denotes the number used to update the service key. Expression 14 denotes that the content server 130 encrypts the service key and number using the temporary service access key and transfers the encrypted service key and number to the mobile terminal 110. The encryption may be performed in various ways in which transmission and reception sides can recognize the encrypted data. When the content server 130 updates the service key, the content server 130 transfers kᵢ having been used to generate a new service key to the mobile terminal 110 together with an ECM. Thereafter, when SKᵢ is periodically updated, the content server 130 selects a new kᵢ₊ⱼ and hashes the selected kᵢ₊ⱼ together with previously used SKᵢ thereby generating SKᵢ₊ⱼ, that is, the new service key. Here, j denotes a number. Also, the content server 130 transfers kᵢ₊ⱼ to the mobile terminal 110 together with the ECM so that respective users can update SKᵢ.

The content server 130 transfers the scrambled content to the mobile terminal 110 (S330).

E_{SKi}[CW] [Expression 15]

In Expression 15, Skᵢ denotes the service key, and CW denotes the control word. Expression 15 denotes that the content server 130 scrambles the content using the control word, encrypts the scrambled content using the service key, and transfers the encrypted content to the mobile terminal 110. The encryption may be performed in various ways in which transmission and reception sides can recognize the encrypted data. Since only the ECM for transferring the control word is used, a load of a wireless bandwidth caused by using an EMM and the ECM can be reduced.

The mobile terminal 110 updates the service key on the basis of the number (S340). For example, when the content server 130 updates the service key and transfers additional content, the mobile terminal 110 may descramble the additional content using the service key updated on the basis of the number. For example, the service key is updated using kᵢ₊ⱼ, and j denotes the number.

The mobile terminal 110 descrambles the content using the updated service key (S350). The mobile terminal 110 may receive the IPTV content by descrambling the content.

Steps 310 to 350 may be repeatedly performed in sequence, and may be performed on an additional mobile terminal 110a.

The present disclosure may have the following effects. However, this does not mean that a specific embodiment should have all or only the following effects. Thus, the scope of the present disclosure should not be understood as being limited to these effects.

A method of transmitting and receiving content according to an embodiment can reduce communication overhead resulting from a conventional CAS-based security system in a mobile IPTV environment. Also, security delay can be reduced in the mobile IPTV environment. Further, an IPTV service can be provided through a mobile terminal that a user wants to use in a safe way anywhere in a mobile IPTV service environment whenever the user wants.

A method of transmitting and receiving content according to an embodiment can limit a registration and key-exchange method of registering a mobile terminal when a subscriber of an IPTV service wants to receive the IPTV service through the mobile terminal that the subscriber wants, and safely distributing a key used to scramble received media content. Thus, the service and content can be secured in the mobile terminal that the subscriber wants without using a CAS.

A method of transmitting and receiving content according to an embodiment can enable service authentication and key exchange to establish a security channel with a multimedia content server without using a CAS when a mobile terminal wants to continuously receive an IPTV service while mobile.

The foregoing is illustrative of the present disclosure and is not to be construed as limiting thereof. Although numerous embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A method of transmitting and receiving content, comprising:
(a) transferring, at a content server, a service key to a mobile terminal;
(b) transferring, at the content server, a number to the mobile terminal;
(c) scrambling, at the content server, content and transferring the scrambled content to the mobile terminal;
(d) updating, at the mobile terminal, the service key on the basis of the number; and
(e) descrambling, at the mobile terminal, the scrambled content using the updated service key.

2. The method according to claim 1, wherein step (a) includes:
transferring, at the content server, the service key to the mobile terminal;
scrambling, at the content server, other content and transferring the scrambled other content to the mobile terminal; and
descrambling, at the mobile terminal, the scrambled other content using the service key.

3. The method according to claim 1, wherein steps (a) to (e) are repeatedly performed in sequence.

4. The method according to claim 1, wherein the content server encrypts the service key and the number using a first service access key corresponding to a second service access key, and an identity (ID) and secure ID of the mobile terminal.

5. The method according to claim 4, wherein the second service access key has a value corresponding to a master secret key and the ID of the mobile terminal, and
the secure ID has a value corresponding to the ID and an authority ID of the mobile terminal.

6. The method according to claim 1, wherein step (c) includes scrambling the content using a control word, encrypting the scrambled content using the service key, and transferring the encrypted content.

7. The method according to claim 6, wherein the control word varies at predetermined time intervals.

8. The method according to claim 1, further comprising, before step (a):
(h) transferring, at a set-top box, an ID and profile of the set-top box to an authentication server;
(i) generating, at the authentication server, the authority ID having a value corresponding to the ID of the set-top box and an initial service key, and the master secret key having a value corresponding to a master key and the ID of the set-top box; and
(j) transferring, at the authentication server, the authority ID to the set-top box.

9. The method according to claim 8, further comprising:
(k) transferring, at the mobile terminal, the ID and a profile of the mobile terminal to the set-top box;
(l) generating, at the set-top box, the secure ID and the second service access key; and
(m) transferring, at the set-top box, the secure ID and the second service access key to the mobile terminal, and transferring the ID, the secure ID, and the profile of the mobile terminal and the second service access key to the authentication server.

10. The method according to claim 9, further comprising:
(n) generating, at the mobile terminal, a first authentication code having a value corresponding to the second service access key, the ID of the mobile terminal, the ID of the set-top box, and the secure ID, and transferring the secure ID and the first authentication code to the content server;
(o) transferring, at the content server, the secure ID and the first authentication code to the authentication server;
(p) authenticating, at the authentication server, the first authentication code, generating the first service access key, and transferring the ID of the mobile terminal and the first service access key to the content server;
(q) generating, at the content server, the service key and a second authentication code having a value corresponding to the first service access key and the ID of the mobile terminal; and
(r) encrypting, at the content server, the second authentication code using the first service access key and transferring the encrypted second authentication code to the mobile terminal, and authenticating, at the mobile terminal, the second authentication code.

11. The method according to claim 10, wherein step (p) includes authenticating, at the authentication server, the first authentication code by determining whether the first authentication code received from the mobile terminal and the first authentication code generated by the authentication server are the same.

12. The method according to claim 10, wherein step (r) includes authenticating, at the mobile terminal, the second authentication code by determining whether the second authentication code received from the content server and the second authentication code generated by the mobile terminal are the same.

13. A method of transmitting and receiving content, comprising:
(a) receiving, at a mobile terminal, a service key from a content server;
(b) receiving, at the mobile terminal, a number from the content server;
(c) receiving, at the mobile terminal, scrambled content from the content server;
(d) updating, at the mobile terminal, the service key on the basis of the number; and
(e) descrambling, at the mobile terminal, the scrambled content using the updated service key.

14. The method according to claim 13, wherein step (a) includes:
receiving, at the mobile terminal, the service key from the content server;
receiving, at the mobile terminal, scrambled other content from the content server; and
descrambling, at the mobile terminal, the scrambled other content using the service key.

15. The method according to claim 13, wherein steps (a) to (e) are repeatedly performed in sequence.

16. The method according to claim 13, wherein step (c) includes scrambling the content using a control word, encrypting the scrambled content using the service key, and transferring the encrypted content.

17. The method according to claim 13, further comprising, before step (a):
(h) transferring, at a set-top box, an identity (ID) and a profile of the set-top box to an authentication server;
(i) generating, at the authentication server, an authority ID having a value corresponding to the ID of the set-top box and an initial service key, and a master secret key having a value corresponding to a master key and the ID of the set-top box; and
(j) transferring, at the authentication server, the authority ID to the set-top box.

18. The method according to claim 17, further comprising:
(k) transferring, at the mobile terminal, an ID and a profile of the mobile terminal to the set-top box;
(l) generating, at the set-top box, a secure ID and a second service access key; and
(m) transferring, at the set-top box, the secure ID and the second service access key to the mobile terminal, and transferring the ID, the secure ID, and the profile of the mobile terminal and the second service access key to the authentication server.

19. The method according to claim 18, further comprising:
(n) generating, at the mobile terminal, a first authentication code having a value corresponding to the second service access key, the ID of the mobile terminal, the ID of the set-top box, and the secure ID, and transferring the secure ID and the first authentication code to the content server;
(o) transferring, at the content server, the secure ID and the first authentication code to the authentication server;
(p) authenticating, at the authentication server, the first authentication code, generating a first service access key, and transferring the ID of the mobile terminal and the first service access key to the content server;
(q) generating, at the content server, the service key and a second authentication code having a value corresponding to the first service access key and the ID of the mobile terminal; and
(r) encrypting, at the content server, the second authentication code using the first service access key and transferring the encrypted second authentication code to the mobile terminal, and authenticating, at the mobile terminal, the second authentication code.

20. A method of transmitting and receiving content, comprising:
(a) transferring, at a content server, a service key to a mobile terminal;
(b) transferring, at the content server, a number to the mobile terminal;
(c) scrambling, at the content server, content and transferring the scrambled content to the mobile terminal;
(d) having the service key updated on the basis of the number in the mobile terminal; and
(e) having the content descrambled using the updated service key by the mobile terminal.

21. The method according to claim 20, wherein step (a) includes:
transferring, at the content server, the service key to the mobile terminal;
scrambling, at the content server, other content and transferring the scrambled other content to the mobile terminal; and
having the scrambled other content descrambled using the service key by the mobile terminal.

22. The method according to claim 20, wherein steps (a) to (e) are repeatedly performed in sequence.

23. The method according to claim 20, wherein step (c) includes having the content scrambled using a control word, encrypted using the service key, and transferred.

24. The method according to claim 20, further comprising, before step (a):
(h) transferring, at a set-top box, an identity (ID) and profile of the set-top box to an authentication server;
(i) generating, at the authentication server, an authority ID having a value corresponding to the ID of the set-top box and an initial service key, and a master secret key having a value corresponding to a master key and the ID of the set-top box; and
(j) transferring, at the authentication server, the authority ID to the set-top box.

25. The method according to claim 24, further comprising:
(k) transferring, at the mobile terminal, an ID and profile of the mobile terminal to the set-top box;
(l) generating, at the set-top box, a secure ID and a second service access key; and
(m) transferring, at the set-top box, the secure ID and the second service access key to the mobile terminal, and transferring the ID, the secure ID, and the profile of the mobile terminal and the second service access key to the authentication server.

26. The method according to claim 25, further comprising:
(n) generating, at the mobile terminal, a first authentication code having a value corresponding to the second service access key, the ID of the mobile terminal, the ID of the set-top box, and the secure ID, and transferring the secure ID and the first authentication code to the content server;
(o) transferring, at the content server, the secure ID and the first authentication code to the authentication server;
(p) authenticating, at the authentication server, the first authentication code, generating a first service access key, and transferring the ID of the mobile terminal and the first service access key to the content server;
(q) generating, at the content server, the service key and a second authentication code having a value corresponding to the first service access key and the ID of the mobile terminal; and
(r) encrypting, at the content server, the second authentication code using the first service access key and transferring the encrypted second authentication code to the mobile terminal, and authenticating, at the mobile terminal, the second authentication code.
